(19) United States
(12) Patent Application Publication
(10) Pub. No.: US 2011/0253544 A1
(43) Pub. Date: Oct. 20, 2011

(54) Formation Of Nanoporous Materials

(75) Inventor: Dusan Losic, South Australia (AU)

(73) Assignee: UNIVERSITY OF SOUTH AUSTRALIA, Adelaide, South Australia (AU)

(21) Appl. No.: 13/133,378

(22) PCT Filed: Dec. 8, 2009
(86) PCT No.: PCT/AU2009/001588

§ 371 Date: Jul. 7, 2011

(30) Foreign Application Priority Data
Dec. 8, 2008 (AU) 2008906329

(51) Int. Cl. C25D 5/18; C25D 11/02; C25D 21/12; B82Y 30/00; B82Y 40/00

(52) U.S. Cl. 205/50; 205/108; 204/229.4; 977/890; 977/780

(57) ABSTRACT

A process for forming a porous metal oxide or metalloid oxide material, the process including:
providing an anodic substrate including a metal or metalloid substrate;
providing a cathodic substrate;
contacting the anodic substrate and the cathodic substrate with an acid electrolyte to form an electrochemical cell;
applying an electrical signal to the electrochemical cell; and
forming shaped pores in the metal or metalloid substrate by:
(c) time varying the applied voltage of the electrical signal to provide a voltage cycle having a minimum voltage period during which a minimum voltage is applied, a maximum voltage period during which a maximum voltage is applied, and a transition period between the minimum voltage period and the maximum voltage period, wherein the voltage is progressively increased from the minimum voltage to the maximum voltage during the transition period, or
(d) time varying the current of the electrical signal to provide a current cycle having a minimum current period during which a minimum current is applied, a maximum current period during which a maximum current is applied, and a transition period between the minimum current period and the maximum current period, wherein the voltage is progressively increased from the minimum current to the maximum current during the transition period.

### CROSS REFERENCE TO RELATED APPLICATIONS

This application is a National Stage of PCT international patent application number PCT/AU2009/001588, filed 8 Dec. 2009 which claims priority from Australian provisional patent application number 2008906329 filed on 8 Dec. 2008, the contents of which are to be taken as incorporated herein by this reference.

### FIELD OF THE INVENTION

The present invention relates generally to processes for forming nanoporous materials, such as nanoporous aluminium oxide, and to nanoporous materials formed thereby.

### BACKGROUND OF THE INVENTION

Nanoporous materials can be described as organic or inorganic materials containing pores with nano-sized dimensions in a regular arrangement. Typically, the diameter of the pores is in the range from about 1 to 500 nm and the pore density is usually in the range from 10⁹ to 10¹² pores/cm². Nanoporous materials have been used in applications such as molecular sieves, filtration, purification, template synthesis, catalysis, sensing, electronics, photonics, energy storage, and drug delivery.

Porous anodic aluminium oxide (“AAO”) fabricated by a self-ordering electrochemical process is one of the most popular and most studied nanoporous materials. The structure of AAO is typically a hexagonally packed array of self-ordered and vertically aligned columnar cells, each containing a central pore with a diameter ranging from 10 to 400 nm. AAO has attracted attention as a nanoporous material because it is simple and relatively inexpensive to produce. It also has good chemical and thermal stability and hardness. Furthermore, AAO has nano-sized pore structures with a high degree of ordering, uniformity, high density, and pore ratio which are important for numerous applications.

Methods for the formation of AAO are of interest because the material is widely used as a template in the synthesis of various one and two-dimensional nanostructures made from metals, metal oxides, carbon, polymers, and peptides.

AAO is formed by a self-ordering process during electrochemical oxidation of aluminium in an acidic solution in a process commonly referred to as anodization. The oxidation conditions, which are generally accepted as the optimal conditions for formation of AAO, are so called mild anodization (“MA”) or low-field anodization in sulfuric acid at 25 V, oxalic acid at 40 V, and phosphoric acid at 194 V. These oxidation conditions provide AAO having about 63 nm, 100 nm, and 500 nm interpore distances, respectively. However, anodization by MA is very slow (1-2 μm h⁻¹) and typically requires a production time of several days.

An alternative method called hard anodization (“HA”) or high-field anodization has been developed to speed up the process (50-100 μm h⁻¹).

The known MA and HA procedures provide highly ordered AAO with uniform pore diameters and interpore distances. However, AAO materials with different internal pore geometries are of interest for use as a template for formation of complex nanostructures (wires, tubes, rods). Furthermore, nanoporous materials with periodic, asymmetric barriers to molecular movement along pore channels have the potential for use in molecular separation and for the development of advanced separation membranes and devices. Periodic pore structures of some metal oxides could also offer unique optical and photonic properties.

To date, the design of internal pore geometries in AAO, or similar materials, has not been well studied. As might be expected, the task of producing tailored internal pore geometries in a controlled manner is challenging.

AAO with shaped internal pore geometries formed by combining conventional MA and HA processes have been reported (Lee, W., et al. Angew. Chem., Int. Ed. 44, 6050-6054 (2005)). More recently, the reported procedure was improved by introducing a new anodization method called “pulsing anodization” where both MA and HA processes were applied in the same electrolyte (Lee, W. et al. Nature Nanotechnol. 3, 234-239 (2008)). The latter method is based on the application of a short potential pulse of 0.5 s during MA anodization that corresponds to the voltage of HA mode. This allows the creation of modulated pore structures with two periodic diameters. However, this method suffers from a problem of slow current recovery as a result of very fast pulses. Furthermore, the method only produces AAO with simple monotone modulated pore structures and cannot be used to create pores with shaped geometries.

There is a need for processes for forming AAO with tailored internal pore geometries and/or for processes for producing AAO that overcome one or more of the problems of existing processes and/or for processes for forming AAO that provide an alternative to existing processes.

Reference to any prior art in this specification is not, and should not be taken as, an acknowledgment or any form of suggestion that this prior art forms part of the common general knowledge in any country.

### SUMMARY OF THE INVENTION

The present invention has arisen from research on the production of AAO materials with designed internal pore geometries. Specifically, a cyclic anodization process that enables the formation of AAO internal pore structures with complex, shaped geometries was developed. The process is based on the application of a time varying electrical signal during the anodization process. Specifically, we have found that the application of a continuous oscillatory signal which induces or provides a periodic change in anodization current creates corresponding structural changes during pore formation, thus permitting the controlled manipulation of internal pore geometries based on the characteristics of the applied electrical signal (shape, amplitude, and period).

The process of the present invention involves anodization of a metal (valve or transition) or a metalloid substrate. Anodization is an electrolytic passivation process used to increase the thickness of a natural oxide layer on the surface of metal or metalloid substrates.

The present invention provides a process for forming a porous metal oxide or metalloid oxide material, the process including:

providing an anodic substrate including a metal or metalloid substrate;

providing a cathodic substrate;

contacting the anodic substrate and the cathodic substrate with an acid electrolyte to form an electrochemical cell;

applying an electrical signal to the electrochemical cell; and

forming shaped pores in the metal or metalloid substrate by:

(a) time varying the applied voltage of the electrical signal to provide a voltage cycle having a minimum voltage period during which a minimum voltage is applied, a maximum voltage period during which a maximum voltage is applied, and a transition period between the minimum voltage period and the maximum voltage period, wherein the voltage is progressively increased from the minimum voltage to the maximum voltage during the transition period, or

(b) time varying the current of the electrical signal to provide a current cycle having a minimum current period during which a minimum current is applied, a maximum current period during which a maximum current is applied, and a transition period between the minimum current period and the maximum current period, wherein the voltage is progressively increased from the minimum current to the maximum current during the transition period.

It will be appreciated by a skilled addressee that by varying the applied voltage the electrochemical cell that is formed operates in potentiostatic mode, whilst by varying the applied current the cell operates in galvanostatic mode. Both potentiostatic and galvanostatic modes can be used for forming the nanoporous metal oxide or metalloid oxide materials.

The process results in the production of nanoporous metal oxide or metalloid oxide materials in which the internal geometry of the pores that are formed is directly related to the applied voltage or current. For example, application of multiple cycles of a time varying asymmetrical voltage or current signal that is a “saw-tooth” signal results in the formation of pores having an asymmetrical ellipsoidal or “bottle-neck” internal pore structure having a short and smooth curve section at the beginning, a long section in the middle, and a sharp reduced diameter section at the end, with each section corresponding to the start, transition, and end of a single anodization cycle. The number of these structures also corresponds to the number of applied cycles.

The minimum voltage or current period, during which a minimum voltage or current is applied, corresponds to the conditions of a mild anodization process. Likewise, the maximum voltage or current period, during which a maximum voltage or current is applied, corresponds to the conditions of a hard anodization process. The transition period between the minimum voltage or current period and the maximum voltage or current period corresponds to a transition period during which the voltage or current is between mild and hard anodization conditions.

The process of the present invention can be distinguished from prior art processes that involve the use of mild anodization conditions interspersed with relatively short pulses of voltage corresponding to hard anodization conditions. Such processes do not utilise a transition period between the mild and hard anodization conditions.

The acid electrolyte may be a solution containing an inorganic acid or an organic acid. In some embodiments, the acid in the acid electrolyte is selected from the group consisting of phosphoric acid, oxalic acid, and sulfuric acid.

In some embodiments in which the acid electrolyte is phosphoric acid, the minimum voltage is about 100 V and the maximum voltage is about 200 to about 250 V. In some embodiments in which the acid electrolyte is phosphoric acid, the minimum current density is about 1 mA/cm² and the maximum current density is about 300 mA/cm². In some embodiments in which the acid electrolyte is phosphoric acid, the minimum current density is about 5 mA/cm², and the maximum current density is about 150 mA/cm².

In some embodiments in which the acid electrolyte is oxalic acid, the minimum voltage is about 40 V and the maximum voltage is about 110 V. In some embodiments in which the acid electrolyte is oxalic acid, the minimum current density is about 1 mA/cm², and the maximum current density is about 300 mA/cm². In some embodiments in which the acid electrolyte is oxalic acid, the minimum current density is about 1 mA/cm² and the maximum current density is about 150 mA/cm².

In some embodiments in which the acid electrolyte is sulfuric acid, the minimum voltage is about 15 V and the maximum voltage is about 35V. In some embodiments in which the acid electrolyte is sulfuric acid, the minimum current density is about 1 mA/cm², and the maximum current density is about 300 mA/cm². In some embodiments in which the acid electrolyte is sulfuric acid, the minimum current density is about 1 mA/cm² and the maximum current density is about 150 mA/cm².

Any number of cycles of the time varying electrical signal can be used. In some embodiments, the number of cycles is between 1 and 200, inclusive. In some embodiments, the number of cycles is between 5 and 20, inclusive. The number of cycles used will be dictated, at least in part, by the desired length of the pores.

As will be appreciated by a skilled person, the voltage applied to the anodic substrate is directly proportional to the current flowing through the electrochemical cell. Different metals, metalloids, and electrolytes will present a different value of impedance and thus require a different voltage to provide a set value of current. Therefore, it is pertinent to discuss the current flowing through the metal or metalloid substrate.

In some embodiments, the current in the low voltage period is about 1.5 to about 3 mA/cm². This corresponds to conventional mild anodization conditions.

In some embodiments, the low voltage or current period takes the largest proportion of the anodization cycle. For example, the low voltage or current period may take about ¾ of the period.

In the transition period the current starts to increase (J=5 to 60-70 mA cm²) over time. In some embodiments, the time of the transition period is greater than 20 seconds.

In some embodiments, the current in the high voltage or current period is greater than about 100 mA/cm². In some embodiments, the current in the high voltage or current period is less than about 300 mA/cm². Typically, if the current in the high voltage or current period is greater than about 300 mA/cm² pores that are internally flat (i.e. without any ellipsoidal or “bottleneck” profile) are formed. In some embodiments, the anodization current in the high voltage or current period is about 200 to about 270 mA/cm².

In some embodiments, the anodization rate is about 1000 to about 1200 nm min⁻¹. Generally, at higher currents (e.g. 270 mA/cm²) relatively long pore structures (e.g. 3000 nm) are formed. In contrast, with lower currents (e.g. 200-220 mA/cm²) shorter pore structures (e.g. 2000-2400 nm) are formed.

The time varying electrical signal may include a second transition period during which the voltage or current is progressively decreased from the maximum voltage or current to the minimum voltage or current.

In some embodiments, the time varying electrical signal is a cyclic waveform. In this form, the voltage or current is cycled between the maximum voltage or current and the minimum voltage or current. The waveform may have a slope between the minimum and the maximum voltage or current.

The present invention also provides a nanoporous metal oxide or metalloid oxide material formed according to the process of the invention.

The present invention also provides a nanoporous metal oxide or metalloid oxide material having one or more pores with periodic asymmetric internal geometry.

The method of the present invention provides nanoporous metal oxide or metalloid oxide material in which each pore has at least one minimum diameter section, at least one maximum diameter section, and a graded section between each minimum diameter section and maximum diameter section, wherein the diameter of the pore in each graded section varies gradually from the minimum diameter to the maximum diameter.

The present invention also provides an electrochemical cell including:

an anodic substrate including a metal or metalloid substrate;

a cathodic substrate;

an acid electrolyte in contact with the anodic substrate and the cathodic substrate;

electrical means for applying an electrical signal across the anodic substrate and the cathodic substrate; and

signal control means for:

(a) time varying the voltage of the electrical signal to provide a time varying electrical signal including a voltage cycle having a minimum voltage period during which a minimum voltage is applied, a maximum voltage period during which a maximum voltage is applied, and a transition period between the minimum voltage period and the maximum voltage period, wherein the voltage is progressively increased from the minimum voltage to the maximum voltage during the transition period, or

(b) time varying the current of the electrical signal to provide a time varying electrical signal including a current cycle having a minimum current period during which a minimum current is applied, a maximum current period during which a maximum current is applied, and a transition period between the minimum current period and the maximum current period, wherein the voltage is progressively increased from the minimum current to the maximum current during the transition period.

The electrical signal may be a symmetric or asymmetric shaped signal. In some embodiments, the shape of the electrical signal is selected from the group consisting of saw-tooth, square, triangular, and sinusoidal.

The acid electrolyte may be a solution containing an inorganic acid or an organic acid. In some embodiments, the acid in the acid electrolyte is selected from the group consisting of phosphoric acid, oxalic acid, and sulfuric acid.

### BRIEF DESCRIPTION OF THE FIGURES

FIG. 1a shows a scheme of cyclic anodization for formation of nanoporous anodic metal or metalloid oxide material with tailored internal structures.

FIG. 1b shows plots of voltage cycle with the voltage-time (U-t) and current-time (J-t) signals during anodization showing different anodization modes (MA, TA and HA).

FIG. 1c shows a model of proposed changes of pore structures that corresponds to the single electric cycle and anodization modes.

FIG. 2 shows typical shapes of electrical signals (voltage or current) used to perform cyclic anodization. Asymmetrical voltage signals are shown on the top two rows (saw-tooth-flat, and saw-tooth shaped). Symmetrical voltage signals are shown on the bottom two rows (sinusoidal and triangular). Parameters for setting the cyclic anodization process are marked in the box for a single cycle of (a) which includes amplitude (max. signal), period of cycle and number of cycles. Signals were generated by specially developed software based on Labview Software (National Instruments, USA).

FIG. 3 shows representative SEM images of nanoporous anodic aluminium oxide material formed by cyclic anodization in 0.1M phosphoric acid at −1° C. by applying oscillatory voltage signals (U-t) with different amplitudes (180 v to 240 V). The corresponding current-time (J-t) graphs recorded during anodization are presented on the left. (a): Pore structures formed with voltage which generates a higher anodization current (J=300 mA/cm²). (b): Internally structured pores formed by decreasing voltage and generating the anodization current (J=200-270 mA/cm²). (c-d): The reduced length of ellipsoidal pore structures as a result of further decreasing the voltage and the anodization current (J=150 mA/cm² and J=60 mA/cm²) during cyclic anodization. Typical shapes of single pore structures formed during a single cycle (period) are presented in the insets.

FIG. 4a shows anodization current-time graphs (graphs 1-4) recorded during potentiostatic mode using a single voltage cycle and four different amplitudes of voltage signal presented in the four rows of FIG. 2. Anodization modes (MA, TA and HA) associated with the corresponding anodization currents are marked on the graph.

FIG. 4b shows SEM images of formed pore structures during potentiostatic mode using a single cycle corresponding to the four different amplitudes of voltage signal. The generated changes of internal pore geometry associated to the anodization modes (MA, TA, HA) are marked on the pore structure.

FIG. 5a shows voltage-time and current-time graphs and corresponding SEM images of nanoporous anodic aluminium oxide material pore structures formed by cyclic anodization in 0.3 M sulfuric acid at −1° C. during 40 cycles. Voltage signal with sinusoidal shape was used with amplitudes Uₘᵢₙ=15 V, Uₘₐₓ=35V, anodization current J=130-150 mA/cm² and period 0.5 min.

FIGS. 5b-c show a model of formed nanoporous anodic aluminium oxide material with model of single pore with periodically modulated structure showing the fracture made across the edge of pore cells.

FIG. 5d shows a TEM image of a bundle of nanoporous anodic aluminium oxide nanotubes liberated from the nanoporous anodic aluminium oxide material.

FIG. 6 shows SEM images of AAO pore structures formed by galvanostatic cyclic anodization in 0.3 M oxalic acid at −1° C. using different amplitudes of symmetrical current signal (sinusoidal shape, and period t=0.25-1 min). (a): Typical AAO pore structure obtained during long cycling (>20 cycles) showing periodic pores formed across all AAO structure with thickness>60 um. (b): Sinusoidal current signals applied during anodization in galvanostatic mode. (c): A higher resolution image of AAO pore structure shown in (a). (d): AAO pore structures formed by sinusoidal current signal with amplitudes Jₘᵢₙ=2 mA/cm² to Jₘₐₓ=100 mA/cm² and period t=0.25 min showing pore segments with short periodic and circular shapes and length about 100 nm. (e): AAO pore structures formed by sinusoidal current signal with amplitudes Jₘᵢₙ=2 mA/cm² to Jₘₐₓ=100 mA/cm² and period t=1 min showing longer pore segments (200-300 nm) as result of extended period of cycle. (f): AAO pore structures formed by sinusoidal current signal with amplitudes Jₘᵢₙ=2 mA/cm² to Jₘₐₓ=120 mA/cm² and period t=1 min showing a further extension of pore segments (200-300 nm) and changing from spherical shape to bottle-neck shape. (g): AAO pore structures formed by sinusoidal current signals with amplitudes Jₘᵢₙ=2 mA/cm² to Jₘₐₓ=150 mA/cm² period t=1 min showing longer pore segments with a bottle-neck shape.

FIG. 7 shows (a): typical current-time (top) and corresponding voltage-time (bottom) graphs of series cycles obtained during galvanostatic cyclic anodization of aluminium in 0.1 M H₃PO₄ at −1° C. (b): SEM image of AAO with asymmetrical pore structures formed using asymmetrical current signal (amplitudes Jₘᵢₙ=10 mA/cm² to Jₘₐₓ=130 mA/cm², exponential saw-tooth shape, period t=1 min, number of cycles n=15). c) Photo of fabricated AAO showing characteristic reflection and iridescence effect with blue colour, as a result of the interaction of light and its modulated pore structure. Bar scale is 5 mm. (d): Current-time (full-line) and voltage-time (dashed-line) graph of single galvanostatic anodization cycle. (e): SEM image of corresponding pore structure formed by this cycle. The contribution of different anodization conditions (mild, MA, transitional, TA and hard, HA) on formation of pore structure are marked on the graph and the image. Dashed arrows indicate the direction of pore formation. Bar scale is 500 nm.

FIG. 8 shows SEM images of AAO pore structures formed by galvanostatic cyclic anodization in 0.1M H₃PO₄ at −1° C. using different amplitudes of current signal (saw-tooth shape, and period t=1.5 min). (a): AAO pore structures formed by current signal with amplitudes Jₘᵢₙ=10 mA/cm² to Jₘₐₓ=250 mA/cm² showing long bottle-neck shaped pores. Bar scale 2 μm. (b): AAO pore structures formed by current signals with amplitudes Jₘᵢₙ=10 mA/cm² to Jₘₐₓ=200 mA/cm² showing shorter bottle-neck pore shape. Bar scale 1 μm. (c-d): AAO pore structures formed by current signal with amplitudes Jₘᵢₙ=10 mA/cm² to Jₘₐₓ=150 mA/cm² and Jₘₐₓ=100 mA/cm² showing further reduction of pore length and vase-shape geometry. Bar scale 1 μm.

FIG. 9 shows current-time graphs and corresponding SEM images of AAO pore structures formed by galvanostatic cyclic anodization in 0.1 M H₃PO₄ at −1° C. using different characteristics of current signal (amplitudes, shapes and periods). (a-b): AAO pore structures formed by asymmetrical current signal (amplitudes Jₘᵢₙ=10 mA/cm² to Jₘₐₓ=100 mA/cm², exponential saw-tooth shape, and two periods t=2 min and t=0.25 min showing asymmetrical pores, vase-shape geometries and different length. (c-d): AAO pore structures formed by symmetrical current signals with sinusoidal shapes (amplitudes Jₘᵢₙ=15-20 mA/cm² to Jₘₐₓ80-100 mA/cm², periods t=2 min and t=0.25 min) showing symmetrical pores, spherical shape geometries and different length. (e-g): AAO pore structures formed by triangular current (amplitudes Jₘᵢₙ=15-20 mA/cm² to Jₘₐₓ−50-100 mA/cm², period t=0.8-1 min, and time between cycles t=0.5 min, t=15 min and t=0.25 min) showing pores with spherical (symmetrical) shape with different length and different distances between pores. Insets on figures show single pore structure. Dashed arrows indicate direction of pore formation.

FIG. 10 shows (a): AAO membrane with pore gradient layer was formed by galvanostatic cyclic anodization in 0.1 M H₃PO₄ at −1° C. using current signal (saw-tooth) with amplitudes that gradually decreased from Jₘₐₓ first=110 mA/cm² to J_{max last}=50 mA/cm² during 15 minutes of anodization. (b): Minimum amplitude was Jₘᵢₙ=20 mA/cm² and period t=0.5 min. The vertical pore gradient with decreasing pore length and diameter across of AAO membrane from the top to the bottom was formed (c).

FIG. 11 (a): SEM image of AAO with double shaped geometries formed by current cycle which consists of two cycles, saw-tooth and triangular (amplitudes Jₘᵢₙ=10 mA/cm² to Jₘₐₓ=120 mA/cm² for saw-tooth and Jₘᵢₙ=10 mA/cm² to Jₘₐₓ=80 mA/cm² for triangular cycle, periods t=0.25-0.5 min). AAO pores with a long asymmetrical (marked as 1) and a short symmetrical part (marked as 2) correspond to the shapes and amplitudes of applied current cycles (marked as 1 and 2). (b): SEM images of AAO with complex and multifaceted pore geometries formed using the complex profile of current cycle that combines 10 cycles with different shapes such as triangular, square, saw-tooth, amplitudes (Jₘᵢₙ=15 mA/cm² to Jₘₐₓ=80-120 mA/cm²) and periods t=0.25-1.5 min. The shapes of pores and their arrangement were in reasonable agreement with applied current profiles. Dashed arrows indicate direction of pore formation.

FIG. 12 shows (a): designing and formation of AAO with complex pore architectures using multiple cyclic anodization with step three successive cyclic steps which includes cycles with increasing amplitude (Jₘᵢₙ=10 mA/cm², J_{max first}=50 mA cm⁻, J_{max last}=120 mA cm, period t=0.2 min), anodization with double cycle which consists saw-tooth and triangular (amplitudes Jₘᵢₙ=10 mA/cm² to Jₘₐₓ=120 mA/cm² for saw-tooth and Jₘᵢₙ=10 mA/cm² to Jₘₐₓ=80 mA/cm² for triangular shape, periods t=0.25-0.5 min) and at last series of triangular cycles (amplitude Jₘᵢₙ=10 mA/cm² to Jₘₐₓ=70 mA/cm² period t=0.25 min). (b): SEM image of formed AAO showing three distinct layers marked as 1, 2 and 3 with different pore structures that corresponds to these anodization steps. (c): SEM image of pore structures with more details, showing pore with gradient (1), pores with double shaped geometries (2) and pores with short spherical structures on the end (3). Scale bar is 500 nm.

### GENERAL DESCRIPTION OF THE INVENTION

Before proceeding to describe the present invention, and embodiments thereof, in more detail, it is important to note that various terms that will be used throughout the specification have meanings that will be well understood by a skilled addressee. However, for ease of reference, some of these terms will now be defined.

The term “metal or metalloid substrate”, and variants thereof, as used throughout the specification means any conducting or semi-conducting metal or metalloid material that is capable of undergoing anodic oxidation. Such metals are sometimes described as valve metals and transition metals. A metalloid is an element that is neither a metal nor a non-metal but has intermediate properties. Metalloids often behave as semiconductors and can include, for example, boron, silicon and germanium).

The term “anodization”, and variants thereof, as used throughout the specification means an electrolytic passivation process in which the thickness of a natural oxide layer on the surface of a metal or metalloid substrate is increased. In a related manner, the terms “mild anodization” and “MA” mean an anodization process performed at a minimum voltage or current, whilst the terms “hard anodization” and “HA” mean an anodization process performed at a maximum voltage or current.

We have developed a new synthetic approach to form porous metal oxide or metalloid oxide materials with tailored internal pore geometries. By applying a time varying electrical signal during anodization, with diverse shapes, amplitudes and periods, it is possible to control the internal geometry of pore structures by combining mild and hard anodization with a transition period between the mild and hard anodization. Continuously shaped pore structures of porous metal oxide or metalloid oxide material with periodic ellipsoidal and circular internal pore geometries can be formed.

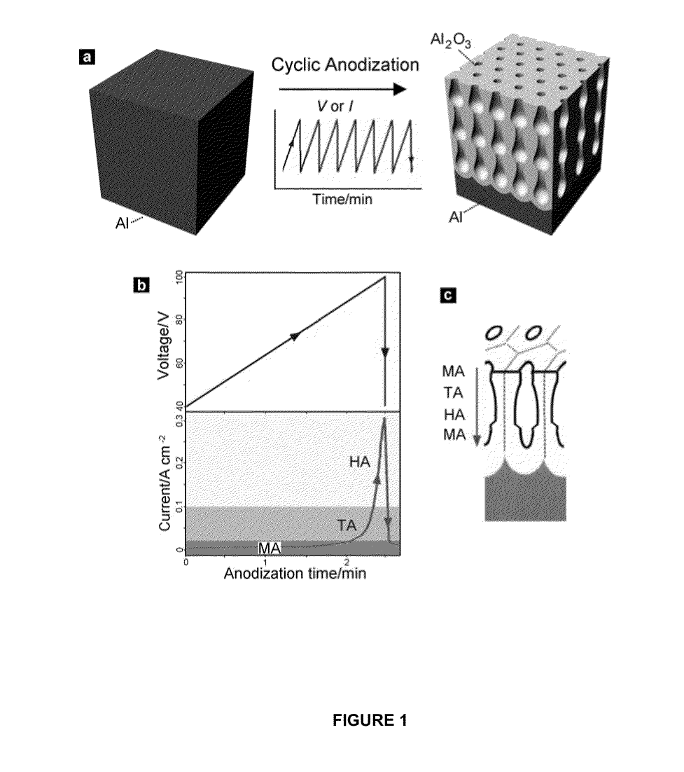

Previous studies have shown that anodization can be performed using MA conditions using a relatively low current (1-5 mA/cm²) and HA conditions using a relatively high current (100-400 mA/cm²) when adequate constant voltages are applied. The present work has shown that, as a result of slow and linear increasing of voltage, the current is also increased (exponentially) from values that correspond to MA anodization conditions to values that correspond to HA anodization conditions. When the voltage is decreased, the current returns to the initial value, passing from HA to MA anodization conditions, thereby creating a pore with two different diameters. Thus, in this work, there is a transition between the MA and HA modes. FIG. 1 shows a model of a pore structure formation using the process of the present invention.

As discussed, the present invention provides a process for forming a porous metal oxide or metalloid oxide material. An anodic substrate including the metal or metalloid substrate and a cathodic substrate are placed in contact with an acid electrolyte to form an electrochemical cell.

The metal or metalloid substrate may be any suitable metal or metalloid substrate that is a conductor or semi-conductor and is capable of undergoing anodic oxidation. Suitable metals include aluminium, titanium, hafnium, zirconium, tantalum, tungsten, niobium, nickel, cobalt, iridium, germanium, and their alloys such as TiAl, Ti Nb, TiAlNb, TiZr Suitable metalloids include silicon, boron and germanium. The metal or metalloid substrate may be in any suitable form, such as a bar, block, wire, film or foil. The substrate is preferably cleaned prior to anodization. For example, the substrate may be cleaned in a solvent (e.g. acetone). Alternatively or in addition, the substrate may be electrochemically polished in a suitable acidic solvent (e.g. 1:4 volume mixture of perchloric acid and ethanol) using a constant voltage to achieve a mirror finished surface.

The process is carried out in an electrochemical cell. The anodization may be carried out at a temperature that is less than room temperature. For example, the electrochemical cell may be equipped with a cooling stage to enable the anodization to be carried out at low temperature. In some embodiments, the anodization is carried out at a temperature of about −1° C.

The acid electrolyte may be a solution containing an inorganic acid or an organic acid. In some embodiments, the acid in the acid electrolyte is selected from the group consisting of sulfamic, citric, boric acid, phosphoric acid, oxalic acid, hydrofluoric and sulfuric acid. In some specific embodiments, the acid in the acid electrolyte is selected from the group consisting of phosphoric acid, oxalic acid, and sulfuric acid.

For the sake of clarity, the metal or metalloid substrate will now be referred to as an aluminium substrate and the material formed using the process of the present invention will be referred to as nanoporous anodic aluminium oxide (“AAO”) material. However, it will be appreciated that the process of the present invention is not limited solely to use with aluminium.

An electrical signal is applied to the electrochemical cell. When a voltage signal is used the process is described as cyclic anodization in potentiostatic mode and when a current signal is used process is called as cyclic anodization in potentiostatic mode. Both voltage or current of the electrical signal is varied to provide a time varying signal. The time varying electrical signal includes a voltage or current cycle having different shapes such as saw tooth, described as asymmetrical, and sinusoidal, triangular and square described as symmetrical. The time varying electrical signal includes a period of cycle, t=0.1-10 minutes, and the number of cycles n=1-1000. A variety of shapes of the time varying electrical signal can be used. Examples include, but are not limited to, sinusoidal, square, and triangle etc. The profile of the time varying electrical signal may be asymmetric (e.g. saw-tooth) or symmetric (e.g. square, triangular, sinusoidal). The time varying electrical signal can also be varied by decreasing or increasing amplitudes of single cycles over a set time period. This results in the formation of AAO with pore gradients. A plurality of time varying signals, each having different profiles, amplitudes and periods, may also be combined into one current or voltage signal during anodization. Alternatively, a plurality of time varying signals may be separated in successive steps. The time varying signals can be designed using commercially available software.

The value controlling electrical signal includes a voltage or current amplitudes, Uₘᵢₙ=10 V to Uₘₐₓ=300 V, Jₘᵢₙ=0.5 mA/cm² to Jₘₐₓ=1000 mA/cm². The minimum voltage or current period during which a minimum voltage or current is applied, a maximum voltage or current period during which a maximum voltage or current is applied, and a transition period between the minimum voltage or current period and the maximum voltage or current period, wherein the voltage or current is progressively increased from the minimum voltage or current to the maximum voltage or current during the transition period.

The characteristics of applied electrical signal during cyclic anodization are preferably controlled by software. To select the optimal parameters for oscillatory electric signal during cyclic anodization to perform pore structuring, it is necessary to consider other parameters including, the choice of electrolyte, electrolyte concentration, temperature, condition of metal surface. These parameters ideally need to maintain the self-ordering of the AAO without disordering, branching, or burning effects.

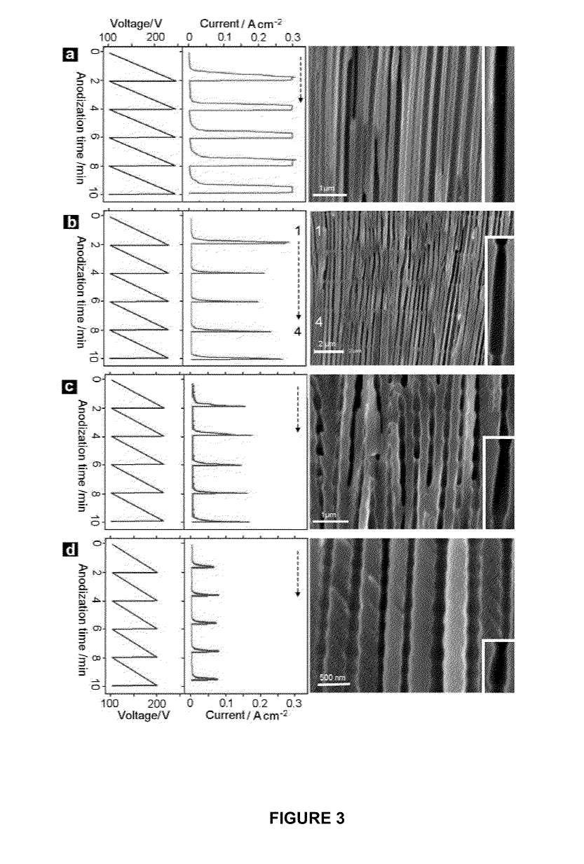

The process of the present invention can be performed by applying a time varying voltage signal (saw-tooth, period t=2 min, amplitudes Uₘᵢₙ=100 V, Uₘₐₓ=200-250 V, and n=5-20 cycles). The maximum amplitude of the voltage signal can be adjusted to set values of the anodization current with different periods of HA, transition anodization (“TA”), and MA modes during a single cycle. A series of representative cross-sectional SEM images of nanoporous AAO material pore structures with corresponding voltage-time and current-time signals recorded during cyclic anodization in phosphoric acid are shown in FIG. 3. The SEM images show the development of pore structure from pores with a flat internal surface, to a series of periodic pore structures with elongated ellipsoidal shapes and different lengths.

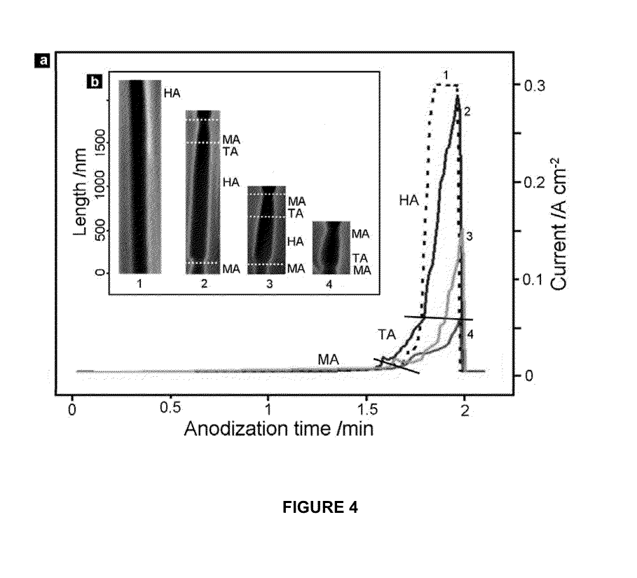

To better understand the formation of these structures the anodization current signal from a single cycle and corresponding pore structure SEM images were analysed in FIG. 4. Three distinctive parts in the anodization current graph relating to the different anodization modes can be distinguished (FIG. 4a). In the first part, at the start of the cycle, the current is steady with values of J=1.5 to 3 mA/cm². This corresponds to conventional MA anodization and takes the largest proportion of the anodization cycle (about ¾ of the period). In the second part, the current signal corresponds to the transition mode, where the anodization current starts to slowly increase (J=5 to 60-70 mA/cm²), before reaching the third and final part, HA mode with a high increase in current (J>100 mA/cm²).

When a high anodization current (J=300 mA/cm²) is passed through both MA/TA and HA modes, but for a majority period in HA mode, only flat pores were formed. The absence of structural changes or pore modulation may be a result of the substantially higher anodization rate or pore growth rate in HA mode (2000-3000 nm min⁻¹) which dominates during this cycling process. The flat pore structures are similar to the pores formed by conventional HA mode at constant voltage formed in control samples. However, when the current is decreased to lower values (J=200-270 mA/cm²) with a lower fraction of time in HA mode, the flat pore structure formation switches into the formation of structured pores (see FIG. 3b, FIG. 4a and FIG. 4b, structure 2).

The long length, ellipsoidal or “bottle-neck” structures across pores were formed with a short and smooth curved section at the beginning, long flat section in the middle, and a reduced diameter section at the end, which corresponds to the start, transition, and end of a single anodization cycle. The number of these structures corresponds to the number of applied cycles. The corresponding current graph (FIG. 4a, graph 2) shows a shorter time in HA mode and lower current values in comparison with previous examples. Thus, decreasing the maximum current (<J=250 mA/cm²) and the duration of HA mode below a certain point may be the initiating factors for triggering the structuring of pores.

Anodization in MA and particularly TA mode during a single cycle resulted in SEM observable structural changes and a bottle-neck pore shape. A decrease in the anodization rate (1000-1200 nm min⁻¹) in comparison with the previous conditions (>2000 nm min⁻¹) confirms this. A very sharp transition in the pore structure was seen at the end, and this corresponds to the transition from HA to MA mode when a dramatic drop off in the anodization current occurs at the end of one cycle and the start of a new cycle. Variation of current values during 5 cycles (FIG. 3b) shows the existence of a strong link between the anodization current and the length of pore structures. At higher anodization currents (J=270 mA/cm², FIG. 3b, cycle 1 and 4) longer structures (I=3000 nm) were created, in comparison with lower currents (J=200-220 mA/cm², cycles 2 and 3) when shorter structures (I=2000-2400 nm) were created. Thus, changes in anodization current during the cyclic process affect the formation of internal pore structures.

When the anodization current during the cyclic process was further decreased (J=150 mA/cm²) similar asymmetrical periodic pore structures were formed as previously, but this time with a significant reduction in length (FIG. 3c, FIG. 4a, graph 3, and FIG. 4b, structure 3). The current graph shows the majority of the cycle period in MA/TA mode, and only a small proportion in HA mode. Therefore, shorter ellipsoidal pore structures with a length of 700-800 nm are formed as a result of dominant anodization in MA/TA mode, and significantly decreased HA mode, which is confirmed by a decrease in the anodization rate (350-400 nm min⁻¹). The pore structures possess an asymmetrical shape with differences in diameter at the beginning and end of the cycle.

By further decreasing of the anodization current (J=60 mA/cm²), shorter or vase-shaped periodical pore structures (FIG. 3d, FIG. 4a, graph 4, FIG. 4b structure 4) can be formed. This anodization process corresponds only to MA and TA mode, which confirms that cycling through HA mode is not essential to obtain structural changes in the pores. In this case the difference in pore growth rate and pore diameter between anodization in MA and TA is the factor that governs the pore structuring. Thus, the transition between MA and HA anodization modes (i.e. TA mode) is important in controlling pore structure formation in the cyclic anodization process.

The anodization conditions between MA and HA modes have previously been reported as not providing a good self-ordering regime. However, this does not appear to be important for the present cyclic anodization process, because self-ordering is managed by the MA or HA modes at the start of the cycle, and anodization in the TA condition only occurs for a short period of time during a single cycle.

In comparison with previous reports where fast pulsing HA (t=0.5 s) during MA anodization is used, the cyclic anodization process described herein provides more flexibility in combining different anodization modes, (MA/TA and MA/TA/HA mode) with the ability to create shaped, asymmetrical or more complex pore structures. In the case of fast pulsing as described in previous reports, the very fast changes between HA and MA modes leads only to the creation of pore structures based primarily on the HA pulse and any contribution of the MA pulse is minimal. This is a limitation of the previously reported approach for the generation of shaped pore structures.

In the process of the present invention, the minimum voltage or current period may be about 20 to 30 seconds which leads to the minimum voltage or current contributing to the pore formation. However, the MA conditions are not necessary and cycling by just the HA and TA modes can be used. Practically, a cyclic anodization with Imin=5 mA/cm² (MA) and Imax=100 mA/cm² (HA) with a period of t<10 min may result in only flat pores being formed, whereas by increasing Imin=20-30 mA/cm² (TA) with the short period it is possible to make shaped pore structures.

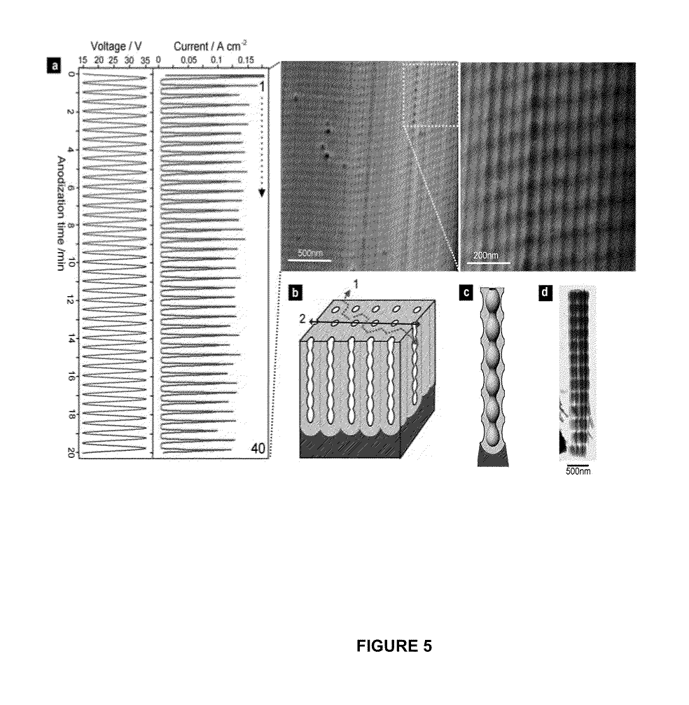

The cyclic anodization process can also be performed with other acids, such as oxalic acid (H₂C₂O₄) and sulfuric acid (H₂SO₄). Examples of nanoporous anodic aluminium oxide material formed with sulfuric acid as the electrolyte and using a sinusoidal time varying signal, with a period of t=0.25 min, and 40 cycles, are shown in FIG. 5a, along with the corresponding anodization current. Sulfuric acid showed superior performance in terms of stability of anodization current and optimisation of cycling conditions. Interestingly, cross-sectional SEM images show the external structure of the hexagonal pore cell rather than the internal pore structure. This occurs because cracks during fracturing of the nanoporous anodic aluminium oxide material formed in sulfuric acid propagate along cell boundaries (FIG. 5b, arrow 1), and not through the centre of the cell as for nanoporous anodic aluminium oxide material formed in the other acids (FIG. 5b, arrow 2).

A model of these structures representing AAO nanotubes with modulated geometry is shown in FIG. 5c. By extensive ultrasonic treatment, these anodic aluminium oxide nanotubes can be separated from the bulk material and dispersed in solution (water). A TEM image of a separated anodic aluminium oxide nanotube bundle is shown in FIG. 5e. Hence, cyclic anodizaton in sulfuric acid provides a process for the formation of nanotubes with controlled length.

Thus, cyclic anodization based on the cycling of voltage can be used for controlled engineering of internal pore structures of anodic aluminium oxide and/or for the formation of nanotubes.

The process of the present invention can also be performed in the galvanostatic mode by adjusting the current in a cyclic manner. Ultimately, it is the current which directs pore formation. In potentiostatic mode the voltage is set in order to achieve the required current. As such, anodization in galvanostatic mode may be advantageous because the current signal is adjusted directly, possibly leading to more reproducible results, better stability and better control of manipulation of pore geometries.

The ability to choose the galvanostatic mode instead of the potentiostatic mode for cyclic anodization is useful when anodization in oxalic acid is performed. During cyclic anodization in potentiostatic mode in 0.3 M H₂C₂O₄ using voltage signals (amplitudes Uₘᵢₙ=40 V, Uₘₐₓ=110V, period t=0.5 min, saw-tooth shape) changes in geometry of pore structures as a result of a spontaneous increase (drift) of anodization current (J=70-110 mA/cm²) were occasionally observed. This behaviour of spontaneous changes in the anodization current is explained by changes in the properties of the barrier oxide film and its porosity. Although AAO with shaped pore structures was fabricated, the controlling of the pore shapes by electric signal (shape, amplitude, and period) was only poorly reproducible and depended on the initial condition of the surface. Because the generation of the pore structures is directed by generated current during anodization, to avoid this problem it was found that the galvanostatic mode instead of the potentiostatic mode provided controllable pore structuring without spontaneous changes of anodization conditions.

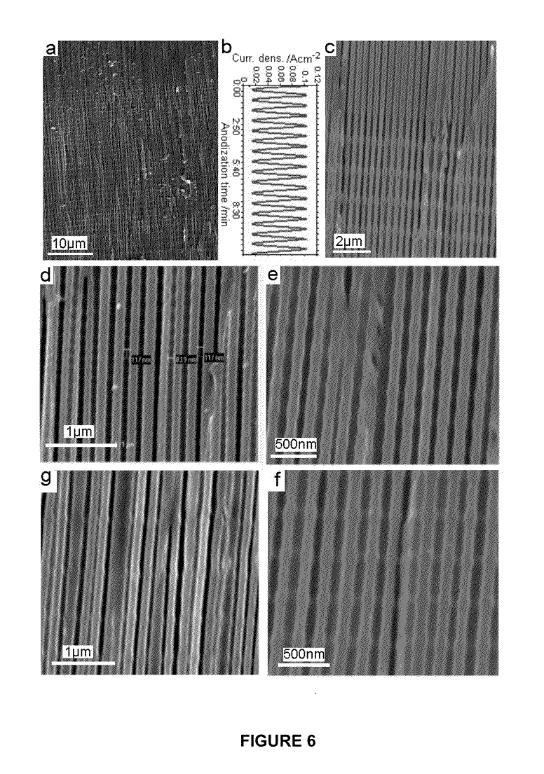

Therefore, in some situations, the galvanostatic cyclic anodization mode showed improved reproducibility and ability to control the shape of pores by characteristics of current signal. Several characteristic examples are shown in FIG. 6 using different amplitudes of symmetrical current signal (Jₘᵢₙ=2 mA/cm² to Jₘₐₓ=150 mA/cm² with sinusoidal shape, and period t=0.25-1 min) showing AAO with different length of pore segment and different shapes (circular and bottle-neck).

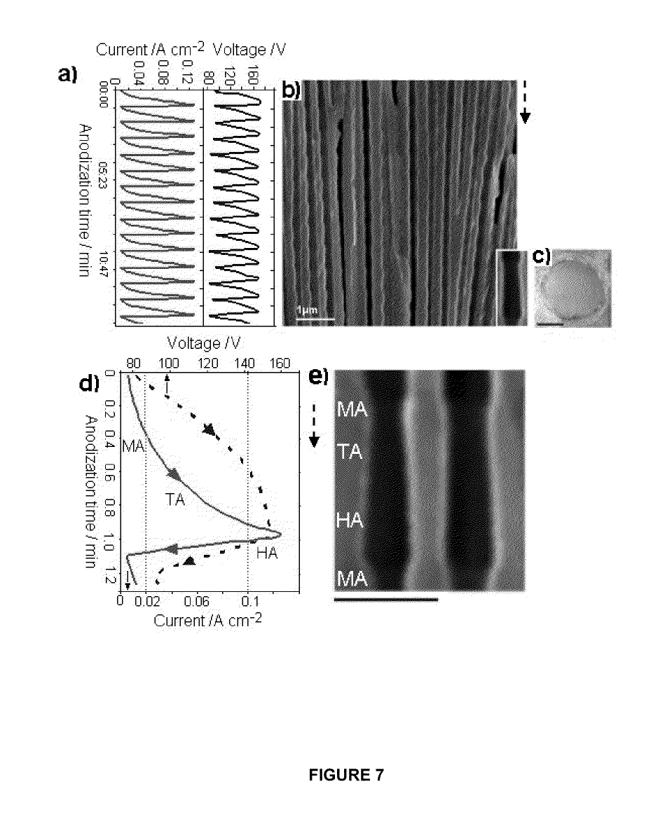

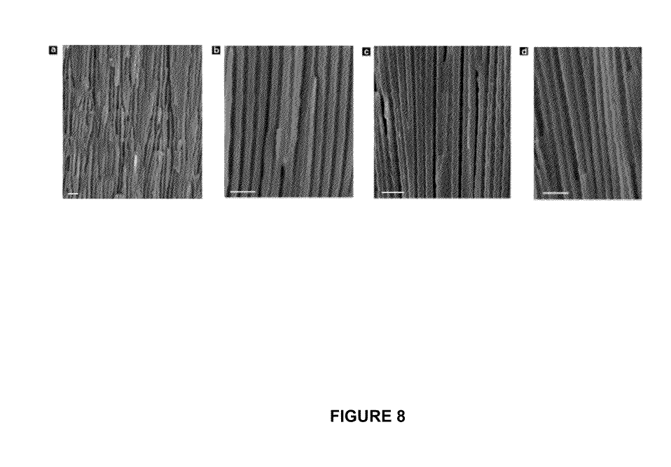

A typical cross-sectional SEM image of AAO pore structures and corresponding current-time signals applied during galvanostatic cyclic anodizaton in H₃PO₄ are presented in FIGS. 7 to 8. To achieve three dimensional pore structuring by cyclic anodization, it is useful to adjust the optimal anodization parameters, which include the current signal shape, amplitude, and period in order to combine the contributions of HA, TA and MA anodization modes during a single cycle. A current density signal that can be applied during a single cycle, and corresponding pore structure formed by this signal, are shown in FIGS. 7 a-b, c-d. Three characteristic parts in the current graph that correspond to MA, TA and HA anodization modes can be distinguished (FIG. 7 d-e). The contribution of each of the anodization modes on the creation of pore structure is marked on the SEM image. The smallest pore diameter corresponds to the minimum current of the applied cycle (MA), the slope in the current corresponds to the main pore shape (TA), and the largest diameter corresponds to the maximum current (HA).

When cyclic anodization is performed using a cycle with high current density (amplitude Jₘₐₓ>300 mA/cm²) only flat pore structures were formed as result of the dominant HA anodization process (data not shown). When the anodization current was decreased (Jₘₐₓ=200-250 mA/cm², Jₘₐₓ=150 mA/cm² and 100-120 mA/cm²) the pore structuring process was switched to the formation of shaped (“bottle-neck”) pore structures, with lengths corresponding to the maximum current (pore length 1500-2000 nm, and 500-800 nm) (FIG. 8a). The observed reduction in the pore length may be explained by the decreasing dominance of HA and increasing contribution of MA/TA conditions during a single cycle, and this is further confirmed by a significant reduction in the anodization rate (from >2000-3000 nm min⁻¹ to less than 1000 nm min⁻¹). By again decreasing the anodization current (Jₘₐₓ=60-80 mA/cm²), shorter or “vase-shaped” periodical pore structures were formed, as shown in FIG. 8 b-d.

The similarity between the asymmetrical profile of the applied current signal and the asymmetrical pore geometry is immediately apparent, and leads to the confirmation of the ability of the process to transfer the profile of the current signal into structural features.

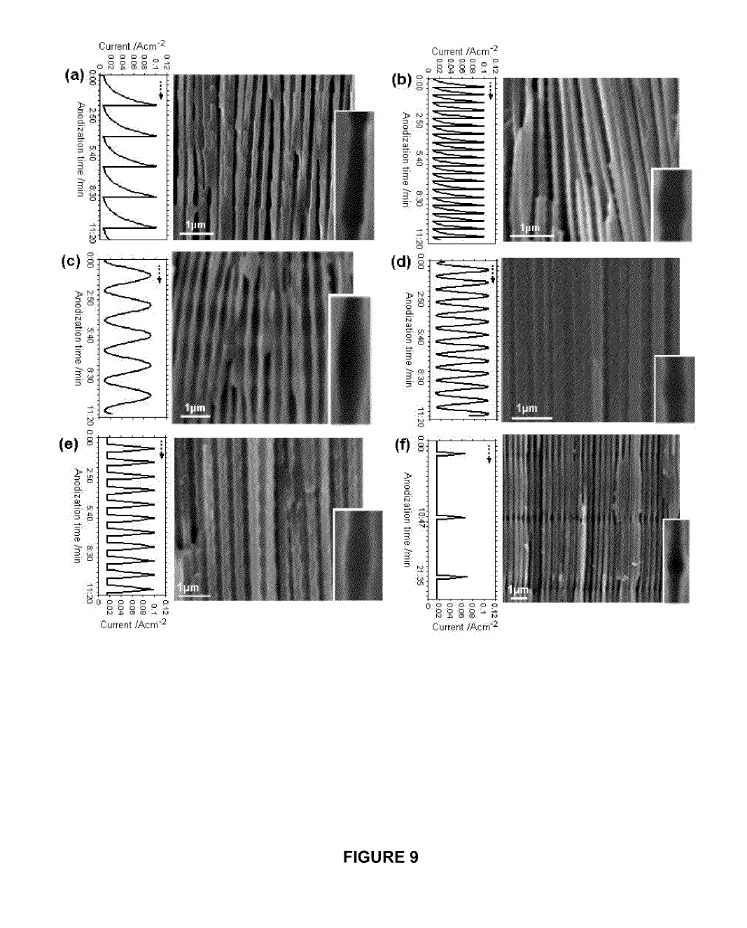

In order to explore the influence of other parameters on pore geometry during cyclic anodization, a series of experiments were performed using current signals with different shapes (asymmetrical, saw-tooth, and symmetrical, sinusoidal, and triangular) and different cyclic periods (t=0.25-10 min) (FIG. 9). SEM images and current profiles applied during anodization show AAO with different pore geometries formed using differently shaped current signals. Asymmetric pore geometry (bottle-neck or vase-shape) was formed by an asymmetric current signal (saw-tooth), and symmetric pore geometries (spherical shape) were formed by symmetric cyclic signals (sinusoidal and triangular). In comparison with pulsing mode where the shape of the very fast pulse does not have an impact on the pore structure, cyclic anodization uses the shape of the current signal to achieve AAO structuring with a different pore geometries.

When a current signal with two different periods (t=2 min and t=0.5 min) and the same amplitude (Jₘₐₓ=100 mA/cm²) was applied during anodization, pore structures with two different lengths were formed. A typical example of formed AAO with an asymmetrical pore structure (“vase” shape) and different pore length (1200 nm and 300 nm) is shown in FIGS. 9a-b, insets. The faster cyclic process decreased the length of the pore structures, but also contributed to a slight deformation of the shape.

Similar results that show the influence of the cyclic period on the length of pore structures were obtained using a sinusoidal (FIGS. 9c-d) and a triangular signal (FIGS. 9e-f-g). FIG. 9e-f shows characteristic examples of the large difference in period (1 min vs. 10 min period), where AAO with short (<100 nm) and long (>5 μm) interpore distances were formed. These results demonstrate that the changing of the period of the current signal controls the length of pore structures and consequently has an influence on the shape of pores particularly when faster cycling is performed.

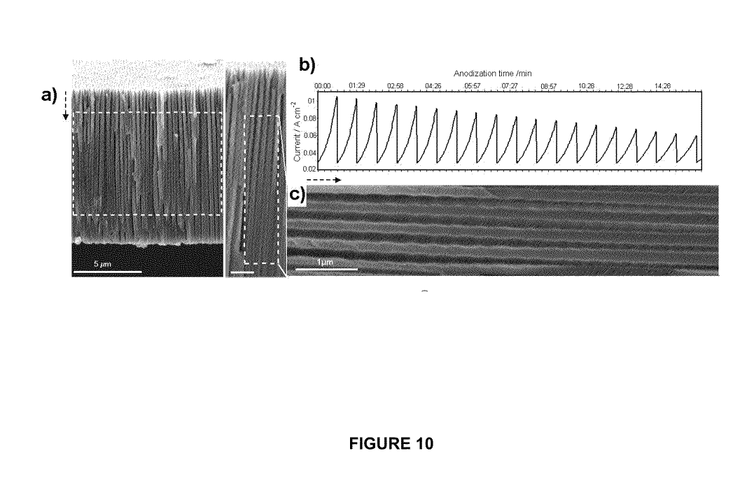

Gradually decreasing or increasing the amplitude of the current signal during the cyclic process may effect the formation of pore structures. SEM images of an AAO membrane formed by galvanostatic cyclic anodization in 0.1 M H₃PO₄ at −1° C. using current signal (saw-tooth) with maximum amplitudes that gradually decreased from J_{first}=110 mA/cm² to Jₗₐₛₜ=50 mA/cm² during 15 minutes of anodization are shown in FIG. 10a. The AAO membrane with a thickness of about 10 μm consists of a vertical pore gradient about 7 μm thick that includes a continuous decrease of pore length (from 700 nm to 100 nm) and diameter from the top to the bottom. These structural features of the formed AAO are in agreement with the profile of applied current signal with decreasing gradient of amplitude. The length of the gradual layer, the pore gradient rate, orientation (decreasing vs increasing), including the pore shape, the length and periodicity can be controlled by changing properties (amplitude, shape, period, gradient, time) of the applied current signal.

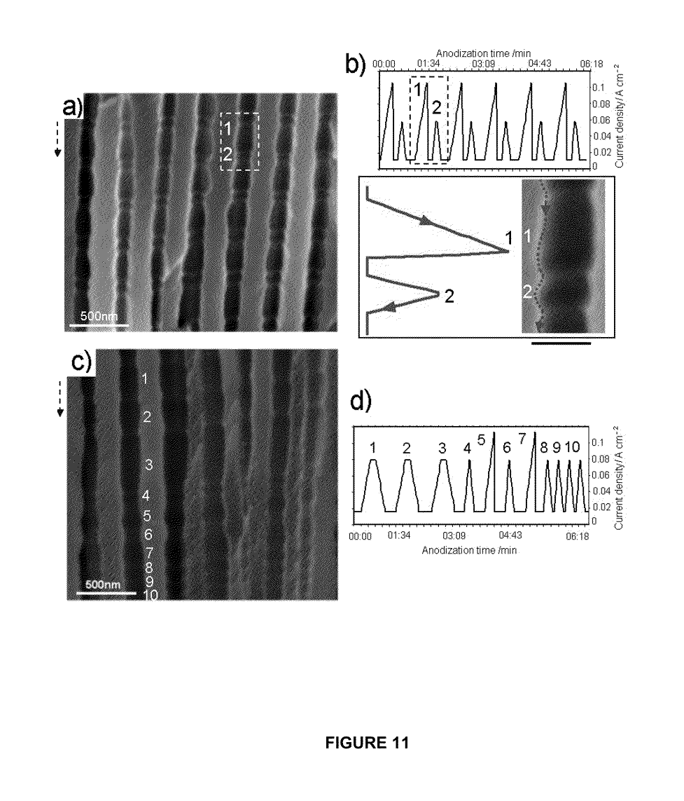

Cycles with combined shapes of electrical signal can also be used. For example, a current signal that combines two cycles with different shapes (asymmetrical, saw-tooth and symmetrical, triangular) and amplitudes (Jₘᵢₙ=10 mA/cm² to Jₘₐₓ=120 mA/cm² for saw-tooth and Jₘᵢₙ=10 mA/cm² to Jₘₐₓ=80 mA/cm² for triangular cycle, periods t=0.25-0.5 min) were applied. SEM images of the formed AAO with periodic, double shaped pore geometry that consists of short symmetrical and a long asymmetrical pores are presented in FIG. 11a-b. The double pore geometries are consistent with the shape, amplitude and period of the individual current signals applied during anodization.

Multi-profiled current cycles can be created by software that combines cycles with different shapes, periods and amplitudes. Results of AAO pores formed by a multi-profiled current cyclic profile are presented in FIG. 11c-d. The formation of a composite pore structure that consists of 5-6 pores in a row with different shapes, symmetry, diameters and lengths confirms that very intricate pore architectures of AAO can be designed and formed.

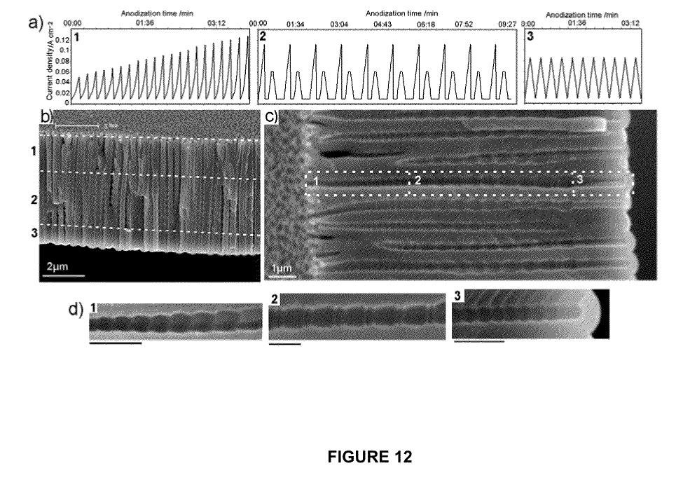

Multiple cyclic anodization that combines successive application of several cyclic steps using different profiles of current signal can also be used for three dimensional nanostructuring of AAO. An example of a formed AAO with multi-segmented pore structures is presented in FIG. 12. Three different successive cyclic anodization steps were applied including cycles with increasing amplitude (Jₘᵢₙ=10 mA/cm², to J_{max last}=120 mA cm), anodization with double cycles which consist of saw-tooth and triangular current signals (amplitudes Jₘᵢₙ=10 mA/cm² to Jₘₐₓ=120 mA/cm², saw-tooth and Jₘᵢₙ=10 mA/cm² to Jₘₐₓ=80 mA/cm², triangular shape) and at last series of triangular cycles (amplitude Jₘᵢₙ=10 mA/cm² to Jₘₐₓ=70 mA/cm²).

SEM images of the resulting AAO membranes (ca 8 μm thick) show three distinct porous layers containing pores with different shapes, diameters, length and gradient. The first layer, which consists of a pore gradient with increasing pore length and diameter, is connected to the second porous layer with the double shaped pores with asymmetrical and symmetrical shapes and layer with short spherical pores at the end.

The nanoporous anodic aluminium oxide materials formed according to the processes of the present invention may be used as a template for fabrication of nanowires, nanorods and nanotubes with tailored geometries. These structures also have the potential to act as parallel and multiple stacked Brownian ratchets at the nanoscale.

### DESCRIPTION OF PREFERRED EMBODIMENTS

### Example 1

### Preparation of Substrate

A high purity (99.997%) aluminium foil supplied from Alfa Aesar (USA) was used as the substrate material. The foil was cleaned in acetone and then electrochemically polished in a 1; 4 volume mixture of HCIO₄ and CH₃CH₂ OH by constant voltage of 20 V for 2 minutes to achieve a mirror finished surface. Two-step anodization was performed using an electrochemical cell equipped with a cooling stage at temperatures of −1° C. The first anodization step was performed in HA mode for 20 minutes in 0.3 M oxalic acid using current density of J=0.15 A cm². Afterwards, the formed porous oxide film was chemically removed by a mixture of 6% of phosphoric acid and 1.8% chromic acid for minimum 6 hours at 75° C., followed by cyclic anodization performed in either 0.1M phosphoric acid, 0.3M oxalic acid, or 0.3M sulfuric acid. At the beginning of this step, samples were initially anodized at a fixed potential for 5 minutes using common MA condition in each acid to obtain an initial porous film with MA barrier layer.

### Example 2

### Cyclic Anodization

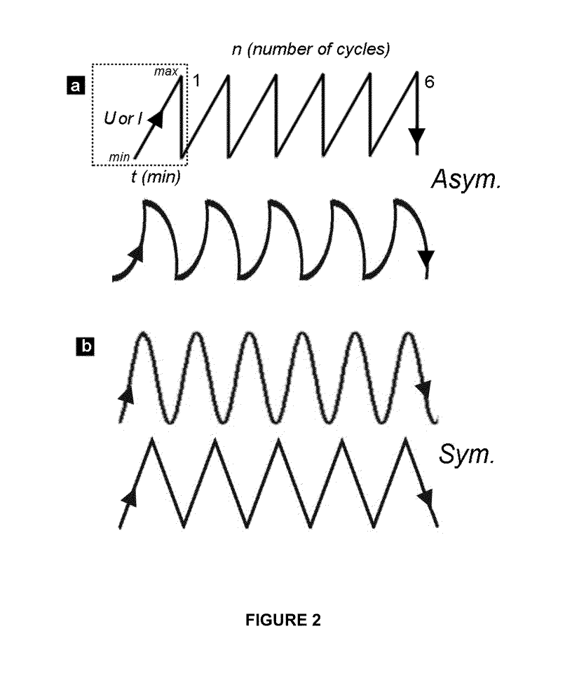

Cyclic anodization was performed using a personal computer controlled power supply (Agilent, USA). Labview based software (National Instrument, USA) was developed to perform controlled anodization, with desired characteristics such as voltage signals (sinusoidal, triangle, square, saw tooth, and their combination, FIG. 2), amplitudes from 20-500 V, periods of cycle from 0.1-10 minutes, and the number of cycles from 1-500. Continuous DC signal can be applied in both potentiostatic and galvanostatic (current) mode. The software is also able to control the maximum anodization current, and the minimum and maximum voltage during the cycling process.

To select the optimal parameters for cyclic anodization which will perform pore structuring, parameters including, electrolyte composition, concentration, temperature, anodization mode, and voltage/current values related to the characteristics of the generated voltage cycle need to be considered. These parameters need to balance the self-ordering of AAO without disordering, branching, or burning effects. The voltage cycle, optimal amplitudes (maximum/minimum), and cycling periods were adjusted to correspond to the desired anodization currents and modes (MA and HA) during the cyclic process. To select these parameters, in particular to optimize anodization current, we performed an initial step of a single voltage scan in linear sweep mode by slowly increasing voltage for 3-5 minutes.

The scanning voltage ranges were selected as 50-250 V for phosphoric acid, 40-120 V for oxalic acid and 20-60 V for sulfuric acid. Based on current-voltage curves obtained from these scans, parameters for voltage cycling signal were then selected. This step was found to be necessary in preventing inconsistency during anodization as a result of variation of sample pre-treatment, purity, crystallinity and surface roughness of Al substrate, and anodization conditions (temperature, mixing, electrolyte composition, electrode distance, etc.).

Cyclic anodization was then performed in different acid solutions using a series of continuously applied periodic voltage signals (average 10-50 cycles per series). Voltage or current cycles with different shapes, amplitudes, and periods were applied in order to explore their impact on controlling pore formation. Voltage-time and current-time signals were continuously recorded during the anodization process. After anodization the remaining Al layer was removed from the prepared AAO films using CuCl₂/HCl solution followed by pore opening in 5% phosphoric acid for 60-70 minutes.

Phosphoric Acid Electrolyte

Cyclic anodization was performed in 0.1 M phosphoric acid at −1° C. by applying both oscillatory voltage and current signals (U-t or I-t). Characteristic examples of fabricated AAO pore structures generated using electric signals—with desired characteristics of oscillatory voltage or current signals with different profiles (saw tooth, sinusoidal, triangle, square, and their combination), amplitudes, Uₘᵢₙ=20 V to Uₘₐₓ=300 V, Jₘᵢₙ=1 mA to Jₘₐₓ=400 mA, period of cycle, t=0.1-30 minutes, and the number of cycles n=1-500. is shown in FIG. 3-4, FIG. 7-11. By selecting cyclic parameters using these electrical signals AAO with modulated pore structures and different pore geometries, (symmetric, asymmetric), periodicity (linear and gradual) were created. Fabrication of AAO with single, double and multi-modulated pore structures, including their hierarchical organization was demonstrated showing the potential of this approach in designing complex 3-d architectures of AAO.

Oxalic Acid Electrolyte

Cyclic anodization was performed in 0.3 M H₂C₂O₄ at −1° C. using different both potentiostatic (voltage) and galvanostatic (current) anodization conditions. During cyclic anodization in potentiostatic mode) the changes in geometry of pore structures as a result of a spontaneous increase (drift) of anodization current (J=70-110 mA/cm²) during cycling process (amplitudes Uₘᵢₙ=40 V, Uₘₐₓ=110V, period t=0.5 min, saw-tooth shape) were observed. Although the AAO with shaped pore structures were fabricated the controlling of the pore shapes by electric signal (shape, amplitude, and period) wasn't reproducible. Therefore the galvanostatic cyclic anodization mode showed improved reproducibility and ability to control the shape of pores by characteristics of current signal. Several characteristic examples is shown in FIG. 6 using different amplitudes of symmetrical current signal (Jₘᵢₙ=2 mA/cm² to Jₘₐₓ=150 mA/cm² with sinusoidal shape, and period t=0.25-1 min) showing AAO with different length of pore segment and different shapes (circular and bottle-neck).

Sulfuric Acid Electrolyte

Cyclic anodization was performed in 0.3 M sulfuric acid at −1° C. using both potentiostatic and galvanostatic mode showing reproducible fabrication of shaped pore structures of AAO. A typical example of anodization using voltage signal with sinusoidal shape was used with amplitudes Uₘᵢₙ=15 V, Uₘₐₓ=35V, anodization current J=130-150 mA/cm² and period 0.5 min is shown in FIG. 5. The model of formed AAO structure with model of single pore with periodically modulated structure showing the fracture made across the edge of pore cells (FIG. 5c). FIG. 5d shows a TEM image of a bundle of AAO nanotubes liberated from AAO membrane.

### Example 3

### Characterisation

Scanning electron microscopy (SEM) Philips XI-30 and transmission electron microscopy (TEM) (Philips CM100) were used to characterize structures of the nanoporous anodic aluminium oxide material formed.

Finally, it will be appreciated that various modifications and variations of the methods and compositions of the invention described herein will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are apparent to those skilled in the art are intended to be within the scope of the present invention.

1. A process for forming a porous metal oxide or metalloid oxide material, the process including:
providing an anodic substrate including a metal or metalloid substrate;
providing a cathodic substrate;
contacting the anodic substrate and the cathodic substrate with an acid electrolyte to form an electrochemical cell;
applying an electrical signal to the electrochemical cell; and
forming shaped pores in the metal or metalloid substrate by:
(a) time varying the applied voltage of the electrical signal to provide a voltage cycle having a minimum voltage period during which a minimum voltage is applied, a maximum voltage period during which a maximum voltage is applied, and a transition period between the minimum voltage period and the maximum voltage period, wherein the voltage is progressively increased from the minimum voltage to the maximum voltage during the transition period, or
(b) time varying the current of the electrical signal to provide a current cycle having a minimum current period during which a minimum current is applied, a maximum current period during which a maximum current is applied, and a transition period between the minimum current period and the maximum current period, wherein the voltage is progressively increased from the minimum current to the maximum current during the transition period.

2. A process according to claim 1, wherein the electrical signal is a symmetric or asymmetric shaped signal.

3. A process according to claim 2, wherein the shape of the electrical signal is selected from the group consisting of saw-tooth, square, triangular, and sinusoidal.

4. A process according to claim 1, wherein the acid electrolyte is a solution containing an inorganic acid or an organic acid.

5. A process according to claim 4, wherein the acid in the acid electrolyte is selected from the group consisting of phosphoric acid, oxalic acid, and sulfuric acid.

6. A process according to claim 5, wherein the acid electrolyte is phosphoric acid, the minimum voltage is about 100 V and the maximum voltage is about 200 to about 250 V.

7. A process according to claim 5, wherein the acid electrolyte is oxalic acid, the minimum voltage is about 40 V and the maximum voltage is about 110 V.

8. A process according to claim 5, wherein the acid electrolyte is sulfuric acid, the minimum voltage is about 15 V and the maximum voltage is about 35V.

9. A process according to claim 1, wherein the number of cycles is between 1 and 200, inclusive.

10. A process according to claim 9, wherein the number of cycles is between 5 and 20, inclusive.

11. A process according to claim 1, wherein the applied current in the low voltage or current period is about 1.5 to about 3 mA/cm².

12. A process according to claim 1, wherein the applied current is increased from about 5 to about 60-70 mA/cm² over time during the transition period.

13. A process according to claim 1, wherein the applied current in the high voltage or current period is about 200 to about 270 mA/cm².

14. A process according to claim 1, wherein the time varying electrical signal includes a second transition period during which the voltage is progressively decreased from the maximum voltage to the minimum voltage.

15. A process according to claim 1, wherein the metal or metalloid substrate is selected from the group including aluminium, titanium, hafnium, zirconium, tantalum, tungsten, niobium, nickel, cobalt, iridium, germanium, boron and silicon, and alloys thereof.

16. (canceled)

17. A nanoporous anodic metal or metalloid oxide material having one or more pores with periodic asymmetric internal geometry.

18. A nanoporous anodic metal or metalloid oxide material in which each pore has at least one minimum diameter section, at least one maximum diameter section, and a graded section between each minimum diameter section and maximum diameter section, wherein the diameter of the pore in each graded section varies gradually from the minimum diameter to the maximum diameter.

19. An electrochemical cell including:
an anodic substrate including a metal or metalloid substrate;
a cathodic substrate;
an acid electrolyte in contact with the anodic substrate and the cathodic substrate;
electrical means for applying an electrical signal across the anodic substrate and the cathodic substrate; and
signal control means for:
(a) time varying the voltage of the electrical signal to provide a time varying electrical signal including a voltage cycle having a minimum voltage period during which a minimum voltage is applied, a maximum voltage period during which a maximum voltage is applied, and a transition period between the minimum voltage period and the maximum voltage period, wherein the voltage is progressively increased from the minimum voltage to the maximum voltage during the transition period, or
(b) time varying the current of the electrical signal to provide a time varying electrical signal including a current cycle having a minimum current period during which a minimum current is applied, a maximum current period during which a maximum current is applied, and a transition period between the minimum current period and the maximum current period, wherein the voltage is progressively increased from the minimum current to the maximum current during the transition period.

20. An electrochemical cell according to claim 19, wherein the electrical signal is a symmetric or asymmetric shaped signal.

21. An electrochemical cell according to claim 20, wherein the shape of the electrical signal is selected from the group consisting of saw-tooth, square, triangular, and sinusoidal.

22. An electrochemical cell according to claim 19, wherein the acid electrolyte is a solution containing an inorganic acid or an organic acid.

23. An electrochemical cell according to claim 22, wherein the acid in the acid electrolyte is selected from the group consisting of phosphoric acid, oxalic acid, and sulfuric acid.
